(19) United States
(12) Patent Application Publication
(10) Pub. No.: US 2026/0247382 A1
(43) Pub. Date: Aug. 20, 2026

(54) LAYER SPLITTING INTERFERENCE CANCELATION IN WIRELESS COMMUNICATION

(71) Applicant: QUALCOMM Incorporated, San Diego, CA (US)

(72) Inventors: Mostafa Khoshnevisan, San Diego, CA (US); Jing Sun, San Diego, CA (US); Chenxi Hao, Beijing (CN); Ahmed Abdelaziz Ibrahim Abdelaziz Zewail, San Diego, CA (US); Xiaoxia Zhang, San Diego, CA (US)

(21) Appl. No.: 19/165,485

(22) PCT Filed: Apr. 27, 2023
(86) PCT No.: PCT/CN2023/091047

§ 371 Date: Sep. 15, 2025

(51) Int. Cl. H04W 72/20; H04L 5/00; H04W 72/044; H04W 76/20

(52) U.S. Cl. CPC H04W 72/20; H04L 5/0051; H04W 72/044; H04W 76/20

(57) ABSTRACT

An apparatus for wireless communication includes a processor coupled to the memory and configured to: receive control information that includes information indicative of parameters related to one or more common streams, wherein the one or more common streams each correspond to one or more common stream resource sets, and wherein the one or more common streams include at least a partial message for at least one user equipment (UE); receive a private stream; determine a common stream resource set from the one or more common stream resource sets; jointly demodulate at least one common stream and the private stream based on parameters related to at least one common stream that corresponds to the common stream resource set to generate at least one demodulated common stream and demodulated private stream; and decode the private stream based at least on the demodulated private stream.

### TECHNICAL FIELD

This disclosure relates generally to wireless communication systems, and more particularly, to interference cancelation.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Some wireless communications systems, such as 4G and 5G systems, may support channel state information (CSI) operations and may also support discontinuous reception (DRX) operations.

As the demand for mobile broadband access continues to increase, research and development continue to advance wireless communication technologies not only to meet the growing demand for mobile broadband access, but to advance and enhance the user experience with mobile communications.

### SUMMARY

The following presents a summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later. While some examples may be discussed as including certain aspects or features, all discussed examples may include any of the discussed features. Unless expressly described no one aspect or feature is essential to achieve technical effects or solutions discussed herein.

This disclosure describes example techniques for transmitting and receiving parameters related to common streams in one or more corresponding common stream resource sets for interference cancelation in layer splitting-based transmissions. Resources or resource sets may refer to components used to enable communication between devices, such as radio resources (e.g., frequency bands, time slots, codes, etc.). A transmitting antenna (e.g., across one or more a transmission reception points (TRPs) and/or base stations) transmits a signal that is combined in air (e.g., a combined signal) that includes at least a first data stream specifically for a first user equipment (UE) (e.g., a first private stream) and a second data stream specially for a second UE (e.g., a second private stream). In layer splitting, the combined signal also includes a common stream that includes messages for the first UE, but not necessarily for the second UE. However, the “common stream” is common in the sense that the second UE uses the common stream for jointly demodulating the common stream and the second private stream, which may assist in interference cancelation. The second UE may then decode the second private stream, and may not decode the common stream.

The example techniques of transmitting and receiving parameters related to one or more common streams, where the one or more common streams each correspond to one or more corresponding common stream resource sets allows a UE to receive parameters related to at least one common stream of the one or more common streams in a common stream resource set that overlaps a resource set (e.g., physical downlink shared channel (PDSCH) resource set) already assigned to the UE. In this manner, by receiving the parameters related to the at least one common stream corresponding to a common stream resource set that overlaps with a resource set already assigned to the UE, the example techniques allow for efficient transmission and reception of the parameters related to the one or more common streams. As noted, the parameters related to at least one common stream may be useful for the joint demodulation of the at least one common stream and the second private stream, which may assist with interference cancelation.

In one example, the disclosure describes an apparatus for wireless communication, comprising: a memory; and a processor coupled to the memory and configured to: receive control information that includes information indicative of parameters related to one or more common streams, wherein the one or more common streams each correspond to one or more common stream resource sets, and wherein the one or more common streams include at least a partial message for at least one user equipment (UE); receive a private stream that is specific for the apparatus; determine a common stream resource set from the one or more common stream resource sets; jointly demodulate at least one common stream of the one or more common streams and the private stream based on parameters related to at least one common stream that corresponds to the common stream resource set to generate at least one demodulated common stream and demodulated private stream; and decode the private stream based at least on the demodulated private stream.

In one example, the disclosure describes a system for wireless communication, comprising: a memory; and a processor coupled to the memory and configured to: generate a common encoded stream and a first encoded stream based on messages for a first user equipment (UE); generate a second encoded stream based on messages for a second UE; pre-code the first encoded stream, the common encoded stream, and the second encoded stream to generate a combined signal that is to be received by the first UE and the second UE, the combined signal including a first private stream based on the first encoded stream, a common stream based on the common encoded stream, and a second private stream based on the second encoded stream; transmit control information that includes information indicative of parameters related to the common stream, wherein the common stream corresponds to one or more common stream resource sets; and transmit the combined signal.

In one example, the disclosure describes a method of processing wireless communication, comprising: receiving, with an apparatus, control information that includes information indicative of parameters related to one or more common streams, wherein the one or more common streams each correspond to one or more common stream resource sets, and wherein the one or more common streams include at least a partial message for at least one user equipment (UE); receiving a private stream that is specific for the apparatus; determining a common stream resource set from the one or more common stream resource sets; jointly demodulating at least one common stream of the one or more common streams and the private stream based on parameters related to at least common stream that corresponds to the common stream resource set to generate at least one demodulated common stream and demodulated private stream; and decoding the private stream based at least on the demodulated private stream.

In one example, the disclosure describes a method of transmitting wireless communication, comprising: generating a common encoded stream and a first encoded stream based on messages for a first user equipment (UE); generating a second encoded stream based on messages for a second UE; pre-coding the first encoded stream, the common encoded stream, and the second encoded stream to generate a combined signal that is to be received by the first UE and the second UE, the combined signal including a first private stream based on the first encoded stream, a common stream based on the common encoded stream, and a second private stream based on the second encoded stream; transmitting control information that includes information indicative of parameters related to the common stream, wherein the common stream corresponds to one or more common stream resource sets; and transmitting the combined signal.

These and other aspects of the technology discussed herein will become more fully understood upon a review of the detailed description, which follows. Other aspects and features will become apparent to those of ordinary skill in the art, upon reviewing the following description of specific examples in conjunction with the accompanying figures. While the following description may discuss various advantages and features relative to certain examples, implementations, and figures, all examples can include one or more of the advantageous features discussed herein. In other words, while this description may discuss one or more examples as having certain advantageous features, one or more of such features may also be used in accordance with the other various examples discussed herein. In similar fashion, while this description may discuss certain examples as devices, systems, or methods, it should be understood that such examples of the teachings of the disclosure can be implemented in various devices, systems, and methods.

### BRIEF DESCRIPTION OF DRAWINGS

FIG. 1 illustrates an example of a wireless communications system that supports layer splitting in accordance with one or more aspects of the present disclosure.

FIG. 2 illustrates an example of private streams and a common stream outputting to user equipment (UEs).

FIGS. 3A-3D illustrate examples of overlapping resource sets between UEs.

FIG. 4 illustrates an example of control information that indicates resource sets and codepoints for joint demodulation of common and private streams.

FIGS. 5A and 5B illustrate examples of overlapping resource sets that UEs access.

FIGS. 6A and 6B illustrate additional examples of overlapping resource sets that UEs access.

FIG. 7 is a block diagram illustrating an example of a hardware implementation for a UE according to some aspects of this disclosure.

FIG. 8 is a block diagram illustrating an example of a hardware implementation for a network entity according to some aspects of this disclosure.

FIG. 9 is a flowchart illustrating an example method of processing a wireless communication for layer splitting.

FIG. 10 is a flowchart illustrating an example method of transmitting wireless communication for layer splitting.

### DETAILED DESCRIPTION

Wireless communications systems may include multiple communication devices such as user equipment (UEs) and base stations (e.g., network entities), which may provide wireless communication services to the UEs. For example, such base stations may be next-generation NodeBs or giga-NodeBs (either of which may be referred to as a gNB) that may support multiple radio access technologies (RATs) including fourth generation (4G) systems, such as Long Term Evolution (LTE) systems, as well as fifth generation (5G) systems, which may be referred to as New Radio (NR) systems. Some UEs may support reference signal transmission, reception, and reporting.

A transmit antenna across one or more transmission reception points (TRPs) or base stations transmits a signal that is combined in air, combined at the transmit antenna, or combined earlier (e.g., combined signal). The term combined signal is used to describe the signal that is combined, whether that happens at the transmit antenna, earlier by a processor, or combined in air.

The combined signal includes a first private stream based on messages for a first UE, and includes a second private stream based on message for a second UE. Prior to the transmission, a pre-coder may pre-code the messages for the first UE and the second UE to generate the first and second private streams.

For example, the pre-coder receives a first encoded stream (e.g., that forms into the first private stream) and a second encoded stream (e.g., that forms into the second private stream). The pre-coder may determine pre-coding parameters for the first encoded stream and the second encoded stream based on the channel estimation of the first UE and the second UE to generate the first private stream and the second private stream. In some examples, the pre-coder may determine the pre-coding parameters such that the second private stream minimally interferes with the first private stream when the first UE receives the combined signal, and the first private stream minimally interferes with the second private stream when the second UE receives the combined signal. Such pre-coding techniques are referred to as interference nulling at the transmitter (TX) (e.g., zero forcing/SLR (signal to leakage ratio) precoding).

While interference nulling at the TX can reduce or suppresses some of the interference, there may be additional interference canceling techniques that can be utilized to further minimize interference. One example technique to further minimize interference is layer splitting. In layer splitting, messages for the first UE is split into two sets of layers. The first set of layers includes a first set of messages for the first UE, and the second set of layer includes a second set of messages for the first UE. The first set of messages and the second set of messages may refer to modulated data symbols after encoding (for example, both first and second sets of layers or both first and second sets of messages correspond to the same codeword or transport block). In layer splitting, the first set of messages (e.g., after encoding) for the first UE may be considered as the first encoded stream, and the second set of messages (e.g., after encoding) may be considered as a common encoded stream. The second encoded stream for the second UE may be the same as above.

The pre-coder may pre-code the first encoded stream to generate the first private stream (e.g., for the first UE) and pre-coded the second encoded stream to generate the second private stream (e.g., for the second UE), as above. The pre-coder may also pre-code the common encoded stream to generate a common stream. For the common stream, the pre-coder may select pre-coding parameters that allow the common stream to have sufficient signal strength at the second UE, as explained below. In layer splitting, the common stream(s) may be in a first one or more layers, the private streams may be in other layers.

The common stream is “common” in the sense that, although there may be no message in the common stream for the second UE, the second UE may still perform joint demodulation of the common stream and the second private stream to assist with interference cancelation in the second private stream. For instance, with the modulation order and/or DMRS (demodulation reference signal) configuration of the common stream, the second UE may be able to jointly demodulate the second private stream and the common stream, which can lead to interference cancelation.

Joint demodulation can reduce the impact of interference because the signature of the interference (modulation order and channel) is taken into account rather than treating the interference as unknown noise. While the pre-coders for the first private stream (for the first UE) and the second private stream (for the second UE) may attempt to reduce the inter-user interference by interference nulling techniques, the pre-coder for the common stream attempts to beamform jointly to both UEs (e.g., based on aggregated channels from the TRP(s) to the first and second UEs) because accurate channel estimation is may be useful for joint demodulation.

This disclosure describes example techniques to indicate the parameters related to one or more common streams in one or more corresponding common stream resource sets. As noted above, resources or resource sets may refer to components used to enable communication between devices, such as radio resources (e.g., frequency bands, time slots, codes, etc.). With the example techniques of indicating parameters related to one or more common streams in one or more corresponding common stream resource sets, the example techniques may limit the number of common stream resource sets a UE needs to access and monitor, resulting in efficient techniques to indicate parameters related to common streams.

For instance, in addition to the common stream resource set(s), there may be other examples of resource sets, such as physical downlink shared channel (PDSCH) resource sets. PDSCH resource sets are described for purposes of example and should not be considered limiting. In some examples, a UE may utilize only the overlapping part between the PDSCH resource set assigned to the UE and a common stream resource set.

For example, as described in more detail, a UE may receive control information (e.g., in group-common (GC) downlink control information (DCI) or GC-DCI) that includes information indicative of parameters related to one or more common streams. The one or more common streams may each correspond to one or more common stream resource sets. Also, the one or more common streams may include at least a partial message for at least one UE. The one or more resource sets may be defined by non-overlapping frequency and/or time domain resources. The UE may determine a common stream resource set from the one or more common stream resource sets (e.g., based on which one of the common stream resource sets at least partially overlaps with one or more PDSCH resource sets).

For example, a unicast DCI for the UE may have defined the PDSCH resource set for the UE. The UE may compare the PDSCH resource set with the one or more common stream resource sets, and determine which one of the common stream resource set overlaps (at least partially overlaps) the PDSCH resource set. The UE may select that common stream resource set, and determine parameters from the control information based on the selected common stream resource set.

The UE may jointly demodulate at least one common stream of the one or more common streams and the private stream for the UE based on parameters related to the at least one common stream that corresponds to the common stream resource set to generate at least one demodulated common stream and demodulated private stream. In this example, the common stream does not include any messages for the UE. The UE may then decode the private stream based on at least one the demodulated private stream.

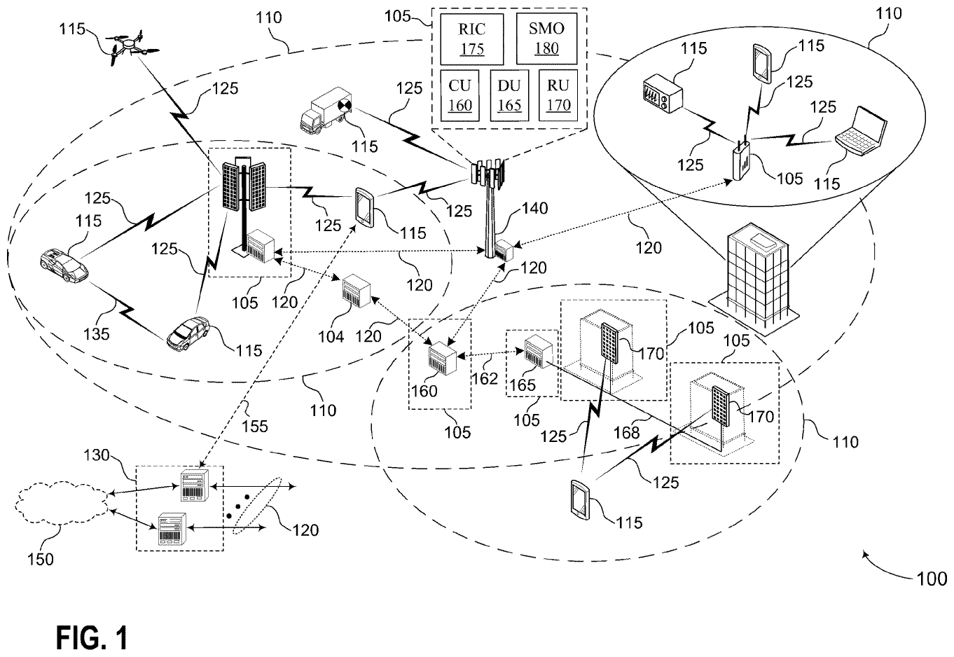

FIG. 1 illustrates an example of a wireless communications system that supports layer splitting in accordance with one or more aspects of the present disclosure. The wireless communications system 100 may include one or more network entities 105, one or more UEs 115, and a core network 130. In some aspects, the wireless communications system 100 may be a Long-Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a network node, a base station, a gNB, a mobility element, a radio access network (RAN) node, or network equipment, among other nomenclature. In some aspects, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein for reference signal processing during a DRX inactive time.

For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples.

Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node.

Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some aspects, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some aspects, network entities 105 may communicate with one another via a backhaul communication link 120 (e.g., in accordance with an X2, Xn, or other interface protocol) either directly (e.g., directly between network entities 105) or indirectly (e.g., via a core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some aspects, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some aspects, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some aspects, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some aspects, the wireless communications system 100 may include network entities 105 or UEs 115 that support concurrent communications using carriers associated with multiple carrier bandwidths. In some aspects, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some aspects, a UE 115 may be configured with multiple BWPs. In some aspects, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some aspects, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some aspects, a carrier may support multiple cells, and different cells may be configured according to different protocol types (e.g., MTC, narrowband IoT (NB-IoT), enhanced mobile broadband (eMBB)) that may provide access for different types of devices.

In some aspects, a network entity 105 (e.g., a base station 140, an RU 170) may be movable and therefore provide communication coverage for a moving coverage area 110. In some aspects, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs 115 via a device-to-device (D2D) communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to each of the other UEs 115 in the group. In some aspects, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some aspects, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some aspects, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some aspects, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some aspects, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170, a TRP) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some aspects, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some aspects, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some aspects, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In accordance with the techniques of this disclosure one or more network entities 105 may be configured to receive a plurality of messages for different UEs 115. For example, a network entity 105 may receive messages W1 for a first UE 115 and messages W2 for a second UE 115. Network entity 105 may be configured to perform layer splitting in which network entity 105 encodes messages W1 to generate a first encoded stream (X1) and a common encoded stream (XC). The first encoded stream and the common encoded stream both include encoded message that are specifically for the first UE 115. The common encoded stream is described in more detail below. Network entity 105 also encodes messages W2 to generate a second encoded stream (X2).

The splitting of messages W1 into a first encoded stream and a common encoded stream may be useful for layer splitting techniques. For instance, network entity 105 may include a pre-coder. The pre-coder may be configured to apply pre-coding parameters to the first encoded stream, the common encoded stream, and the second encoded stream to generate a combined signal based on adding all the streams. One or more transmit antennas (e.g., of one or more network entities 105) transmit the combined signal. In some examples, the combined signal may result from combining in air.

Accordingly, the term “combined signal” is referred to the signal that is combined, and may be combined at the pre-coder, at the one or more transmit antennas, or in the air. For instance, the combined signal is “combined” in the sense that both the first UE 115 and the second UE 115 receive the combination of all streams (e.g., combined over the air, at the pre-coder, or at the transmitting antennas). However, although possible, it may not be required that the combined signal include messages (e.g., decodable content) that are for both the first UE 115 and the second UE 115. For instance, the first encoded stream and the common encoded stream may include messages only for the first UE. The second encoded stream may include messages only for the second UE.

In pre-coding, the pre-coder may determine pre-coding parameters that at least partially suppress interference (e.g., by interference nulling techniques) caused by the combined signal including messages for both the first UE 115 and the second UE 115. For instance, the output of the pre-coder, which may be the combined signal (e.g., the combination of signals that are combined in air, at the pre-coder, or at the antenna), may be considered as having a first private stream for the first UE 115, a second private stream for the second UE 115, and a common stream that includes messages for the first UE, but is useful for the second UE 115, as described in more detail. Because the first UE 115 will receive the combined signal that includes the second private stream, the second private stream may interfere with the first private stream meant for the first UE 115 since both streams may be transmitted on the same resources. Similarly, because the second UE 115 will receive the combined signal that includes the first private stream, the first private stream may interfere with the second private stream meant for the second UE 115 since both streams may be transmitted on the same resources.

The pre-coder may receive channel estimation (e.g., amount of interference, and other channel characteristics) for channels to each of the first UE 115 and the second UE 115. For instance, the channel estimation of the channel to first UE 115 may be represented as H1, and the channel estimation of the channel to the second UE 115 may be represented as H2. The pre-coder may determine pre-coding parameters based on the respective channel estimates of channels to the first UE 115 and the second UE 115 such that the combination of the channel estimate and the pre-coding parameters applied to the first encoded stream and the second encoded stream results in the second private stream being attenuated at the first UE 115, and the first private stream being attenuated at the second UE 115.

Such selection of pre-coding parameters for interference suppression is referred to as interference nulling at the Tx, or zero forcing/SLR (signal to leakage ratio) precoding for private streams. However, additional cancelation, in addition to interference nulling at the Tx may be possible in layer splitting with the common stream.

For instance, the pre-coder may apply pre-coding parameters to the common encoded stream (XC) so that the combined signal includes the common stream. Although the common stream does not include messages for the second UE 115, the second UE 115 may utilize parameters of the common stream for demodulating the second private stream. That is, the second UE 115 may perform joint demodulation on the common stream and the second private stream, which assists with interference cancelation, and then decode the second private stream.

For instance, as described above, joint demodulation can reduce the impact of interference because the signature of the interference (modulation order and channel) is taken into account rather than treating the interference as unknown noise. While the pre-coders for the first private stream (for the first UE 115) and the second private stream (for the second UE 115) may attempt to reduce the inter-user interference by interference nulling techniques, the pre-coder for the common stream attempts to beamform jointly to both UEs 115 (e.g., based on aggregated channels from the TRP(s) to the first and second UEs 115) because accurate channel estimation is may be useful for joint demodulation.

This disclosure describes example techniques for one or more network entities 105 to indicate parameters related to one or more common streams that the second UE 115 can utilize to perform the joint demodulation. From the perspective of the first UE 115, the common stream and the first private stream both include messages for the first UE 115. Therefore, the first UE 115 may demodulate and decode the common stream and the first private stream, and may also perform joint demodulation, although not necessary.

Although the examples are described with a first UE 115 and a second UE 115 and one common stream, the example techniques are not so limited. There may be multiple common streams, and multiple UEs 115. For ease, the examples are described with a first UE 115 and a second UE 115.

In one or more examples described in this disclosure, the first UE 115 and the second UE 115 may be configured to monitor for control information (e.g., monitor a group-common (GC) downlink control information (DCI) or GC-DCI)) for indication of parameters related to one or more common streams in one or more corresponding common stream resource sets. That is, the control information may include information indicative of parameters related to one or more common streams. The one or more common streams each correspond to one or more common stream resource sets. The one or more common streams may include at least a partial message for at least one UE. For instance, XC includes a partial codeword for at least first UE 115.

That is, a codeword for first UE 115 may be split, and XC includes a part of that codeword, and, as described in more detail, another stream may include the other part of that codeword for first UE 115. For example, a message splitter may split the codeword (e.g., message) into the two parts. As an example, one or more network entities 105 may encode and then split a message (e.g., codeword), and parts of the message after splitting may be formed in different streams or layers.

Resources or resource sets may refer to components used to enable communication between devices, such as radio resources (e.g., frequency bands, sub-bands, resource blocks, time slots, codes, etc.). As one example, the first UE 115 and the second UE 115 may monitor the GC-DCI with a certain radio network temporary identifier (RNTI), such as layerSplit-RNTI. Examples of the parameters related to the one or more common streams include modulation order and demodulation reference signal (DMRS) information such as port numbers, DMRS sequence/scrambling, etc. The one or more corresponding common stream resource sets may be defined by non-overlapping frequency domain (resource block (RB)/subbands) and/or time domain (symbols/slots) resources.

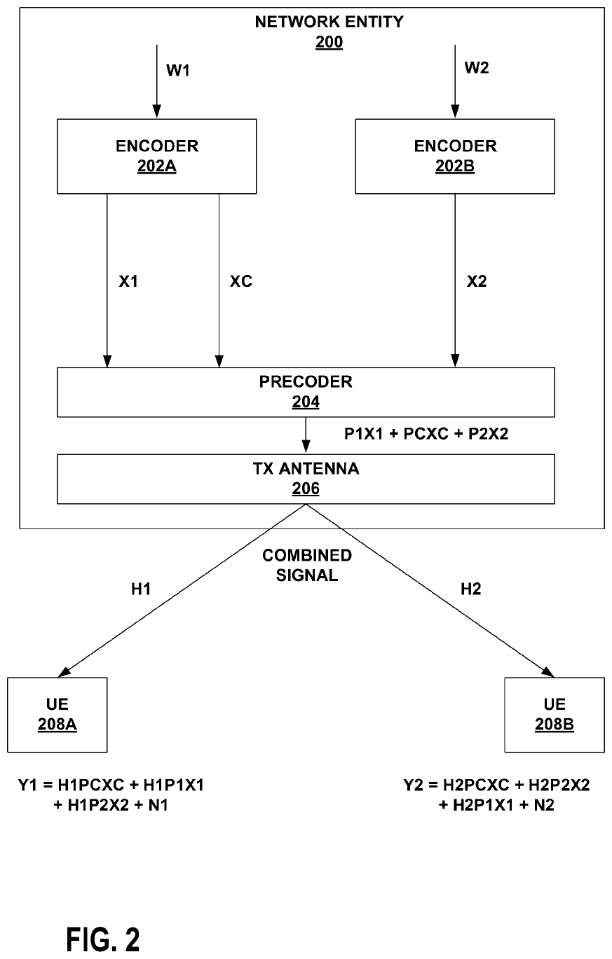

FIG. 2 illustrates an example of private streams and a common stream outputting to user equipments (UEs). FIG. 2 illustrates network entity 200, which is an example of network entity 105 of FIG. 1, and UE 208A and UE 208B. Network entity 200 includes encoder 202A and encoder 202B. Encoder 202A receives a message W1 for UE 208A, and encoder 202B receives a message W2 for UE 208B.

Encoder 202A may be configured to encode message W1 and then partition, or vice-versa, to generate a first encoded stream (X1) and a common encoded stream (XC). That is, as one example, after encoding, encoder 202A may partition message (e.g., a codeword or transport block) into two parts X1 and XC, where X1 and XC may include portions of the same message or codeword. For instance, the first encoded stream (X1) and the common encoded stream (XC) may refer to modulated data symbols after encoding (e.g., both streams correspond to the same codeword or transport block). Encoder 202B may be configured generate a second encoded stream (X2).

Pre-coder 204 may be configured to pre-code the first encoded stream, the second encoded stream, and the common stream. The pre-coding parameter that pre-coder 204 applies to the first encoded stream is P1, the pre-coding parameter that pre-coder 204 applies to the second encoded stream is P2, and the pre-coding parameter that pre-coder 204 applies to the common encoded stream is PC. For example, the output from pre-coder 204 may be a signal represented by P1X1+PCXC+P2X2.

TX antenna 206 may receive the pre-coded stream from pre-coder 204, and then transmits the pre-coded stream. As illustrated, the pre-coded stream is a combined signal. For instance, the combined signal includes first encoded stream (X1) and common encoded (XC), which includes encoded messages for UE 208A, and second encoded stream (X2), which includes encoded messages for UE 208B. However, not all content of the combined signal is for both the UE 208A and UE 208B. The term combined signal is used to indicate the various streams may be combined. This combination may occur at TX antenna 206, pre-coder 204, or may be in air.

As illustrated, the channel of UE 208A is H1 and the channel of UE 208B is H2. In FIG. 2, Y1 represents the data stream that UE 208A receives, and can be represented by Y1=H1PCXC+H1P1X1+H1P2X2+N1, where N1 is noise. That is, Y1 is equal to the pre-coded stream with the channel (H1) applied. Similarly, in FIG. 2, Y2 represents the data stream that UE 208B receives, and can be represented by Y2=H2PCXC+H2P2X2+H2P1X1+N2, where N2 is noise. That is, Y2 is equal to the pre-coded stream with the channel (H2) applied.

H1PCXC or H2PCXC may be considered as the common stream based on whether UE 208A or UE 208B is receiving the combined signal. HIP1X1 may be considered as a first private stream, and H2P2X2 may be considered as a second private stream. In one or more examples, the common stream may be in a first one or more layers, the first private stream may be in a second one or more layers, and the second private stream may be in a third one or more layers

In one or more examples, pre-coder 204 may select pre-coding parameters P1 and P2 to minimize interference at UE 208A and UE 208B. For example, pre-coder 204 may select P2 such that H1P2X2 is a relatively small signal. Therefore, the contribution of H1P2X2 in Y1 (e.g., the signal received by UE 208A) is minimized, where H1P2X2 is interference for UE 208A. Similarly, pre-coder 204 may select P1 such that H2P1X1 is a relatively small signal. therefore, the contribution of H2P1X1 in Y1 (e.g., the signal received by UE 208B) is minimized, where H2P1X1 is interference for UE 208B.

Pre-coder 204 may select the pre-coding parameter PC such that common stream (H1PCXC) and common stream (H2PCXC) are demodulate-able at both UE 208A and UE 208B. For instance, although common encoded stream XC does not include messages for UE 208B, UE 208B may jointly demodulate common stream (H2PCXC) with second private stream (H2P2X2) for additional interference cancelation (e.g., using the signature of the interference based on modulation order and DMRS information). UE 208B may then decode second encoded stream X2 to reconstruct the W2 messages. UE 208A may also perform joint demodulation, followed by decoding the first encoded stream (X1) and the common encoded stream (XC).

In some examples, UE 208B may be considered as a UE that is capable of using parameters such as modulation order and DMRS information of the common encoded stream (XC). UE 208A may be any type of UE that is capable of processing one message with two different modulation orders. For instance, the modulation order of the common encoded stream (XC), and the first encoded stream (X1) may be different since the pre-coding parameters may be different (e.g., pre-coding parameter PC for common encoded stream XC and pre-coding parameter P1 for first encoded stream X1). Moreover, although the above example includes UE 208A and UE 208B, there may be more than two UEs. Accordingly, there may be multiple UEs that are configured to demodulate respective common streams (e.g., HnPCXC), where “Hn” refers to the channel for each of “n” UEs, but XC includes messages only for UE 208A.

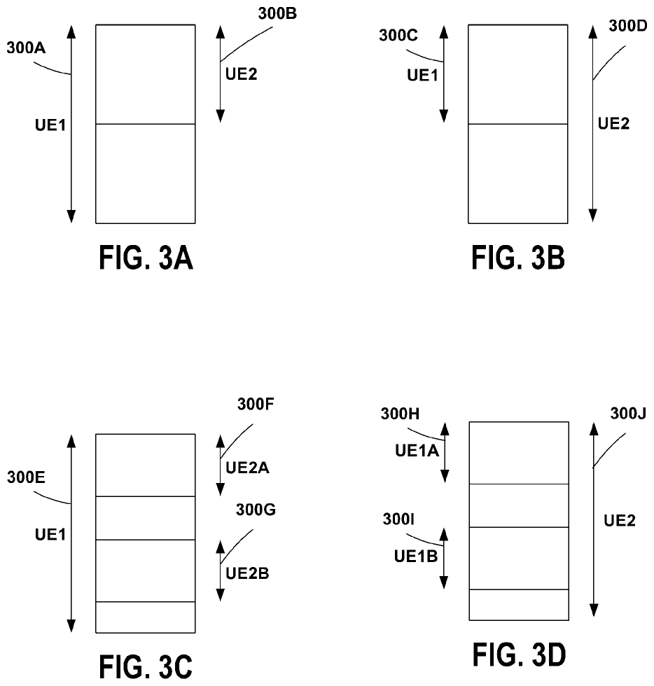

FIGS. 3A-3D illustrate examples of overlapping resource sets between UEs. For instance, FIGS. 3A-3D illustrate some potential advantages of layer splitting techniques. Resources or resource sets, as used in this disclosure, may refer to various components used to enable communication between devices such as radio resources (frequency bands, sub-bands, resource blocks, time slots, codes, etc.), physical resources (e.g., antennas, amplifiers, filters, etc.), network resources (e.g., switches, routers, servers, etc.), spectrum resources (e.g., different frequency bands for the devices), and the like. For ease of illustration, this disclosure describes radio resources as an example of resources or resource sets, but the techniques should not be considered limiting.

In layer splitting, co-scheduled UEs (e.g., UEs that are receiving or transmitting from same set of one or more network entities 105) may have partial overlapping resources, and may not require identical resources. Some other techniques, like rate splitting, in which a common stream includes messages for both UE 208A and UE 208B, the resources may need to fully overlap between UE 208A and UE 208B. Again, in layer splitting, common encoded stream (XC) includes messages for UE 208A and may not for UE 208B. In rate splitting, common encoded stream (XC) includes messages for UE 208A and UE 208B, or both UEs 208A and 208B may require decoding the message of the common stream (e.g., demodulation of the common stream may not be enough for rate splitting, but decoding may be also needed). Although the example techniques are described with respect to layer splitting, the example techniques may be applicable to rate splitting as well.

FIGS. 3A-3D illustrate conceptual diagrams of resources sets for UE1, UE2, UE1A, UE1B, UE2A, and UE2B. Each of these UEs may be examples of UE 208A or UE 208B. For instance, the resource sets in FIGS. 3A-3D may be physical downlink shared channel (PDSCH) resource sets that are assigned to the UEs (e.g., through respective unicast DCI), but other examples of resource sets are possible. In one or more examples, it may be possible to use overlapping portions of resource sets to perform the joint demodulation. That is, different parameters used for the joint demodulation (e.g., for different common streams) may be associated with different resource sets. By determining the overlapping portions of resource sets, the UEs that need to perform joint demodulation can determine which parameters to use.

FIG. 3A illustrates a conceptual diagram of resource set 300A for UE1 and resource set 300B for UE2. As illustrated in FIG. 3A, resource set 300B for UE2 partially overlaps resource set 300A for UE1. FIG. 3B illustrates a conceptual diagram of resource set 300C for UE1 and resource set 300D for UE2. As illustrated in FIG. 3B, resource set 300C for UE1 partially overlaps resource set 300D for UE2. In FIGS. 3A and 3B, if the common encoded stream (XC) includes messages for UE1, then UE2 may be able to jointly demodulate the common stream (e.g., H2PCXC) and the second private stream (e.g., H2P2X2) based on the overlapping resources of the resource sets 300A, 300B for FIG. 3A or 300C, 300D for FIG. 3B. The overlapping resources of the resource's sets may be referred to simply as overlapping resources.

In FIG. 3C, resource set 300E for UE1 overlaps resource set 300F for UE2A and resource set 300G for UE2B. In this example, the same common encoded stream (XC), resulting in common stream (HnPCXC) where n is 2A or 2B, may be demodulated by UE2A in resource set 300F and by UE2B in resource set 300G.

In FIG. 3D, resource set 300J for UE2 overlaps resource set 300H for UE1A and resource set 3001 for UE1B. In this example, UE2 may demodulate a first common encoded stream (XC, A) (e.g., part of message for UE1A) in resource set 300H and a second common stream (XC, B) (e.g., part of message for UE1B) in resource set 300I.

In one or more examples, control information (e.g., in form of a GC-DCI signal) may include information indicative of parameters for one or more common streams, where the information indicative of the parameters is associated with one or more common stream resource sets. For instance, the information indicative of the parameters may be a codepoint value, and the codepoint value may map to set of parameters. As an example, codepoint value of 1 may indicate that the modulation order is 2 (QPSK) and the DMRS information may be port 0.

In one or more examples, X bits may be needed for information indicative of the parameters for each common stream to choose from 2^{X} possibilities (e.g., codepoints) that can be pre-configured to the UE. That is, the UE may store a lookup table that maps each of the 2^{X} codepoints to a particular set of parameters. In some examples, one codepoint may indicate absence of common stream for that particular resource set. Accordingly, if the number of common streams or the number of common stream resource sets is Y, then the total number of bits may be X*Y. For instance, each of the common streams, and therefore, the parameters of each the common streams may be associated with a common stream resource set. Accordingly, if there are Y common streams, there may be Y common stream resource sets.

Each of the Y common stream resource sets may be defined by non-overlapping frequency domain (RB/subbands) and/or time domain (symbols/slots) resources. In one or more examples, because each of the Y common stream resource sets may be defined by separate resources, the parameters for each of the different common streams may be associated with different common stream resource sets. In one or more examples, the UEs may be configured to determine which ones of the common stream resource sets overlap at least a portion of the PDSCH resource set assigned to the UE. Based on the overlap, the UEs may be configured to determine the parameters for the common stream that are to be used for the joint demodulation.

There may be various ways in which to define the common stream resource sets. As one example, A configuration (e.g., RRC) may indicate the granularity from which UE determines the value of Y and the Y common stream resource sets. As another example, the value of Y can be configured (RRC), and the UE determines the Y resource sets in time, in frequency, or in both time and frequency.

In some examples, a UE may be configured to exclude the resources configured for UL transmission before determining the common stream resource sets. In time domain, the granularity may also be a function of monitoring periodicity of the GC-DCI. In some examples, the common stream resource sets can be defined with respect to the symbols/slots in which the GC-DCI is detected (previous slot or next slot may be considered).

Accordingly, in one or more examples, a block in the GC-DCI may include X*Y bits (X bits for the codepoints, and Y representing the number of common stream resource sets). In some examples, there may be multiple blocks in the GC-DCI. The UEs may be configured with a starting position in the GC-DCI for each block. As an example, the RRC may include information that indicates a starting location for the each of the blocks that includes X*Y bits. Different blocks in the GC-DCI may be intended for different groups of UEs. On the other hand, the same block in the GC-DCI may be monitored by multiple UEs. Furthermore, a UE that is configured with multiple serving cells (or component carriers) may need to monitor different blocks in the GC-DCI corresponding to the different serving cells. Hence, indicating (by RRC signaling) one or more starting locations for one or more blocks in the GC-DCI allows for various flexibilities as described above.

The UE may be configured (e.g., by RRC) with an overall payload size of the control information (e.g., overall DCI payload size). For instance, some blocks may not be configured for a particular UE, but the UE may need to decode the DCI before being able to parse the blocks.

The number of bits in each block may be based on the number of resource sets Y. For instance, the parameters for each of the common streams may be X bits, and there may be Y resource sets. Therefore, within a block, there may be X*Y bits.

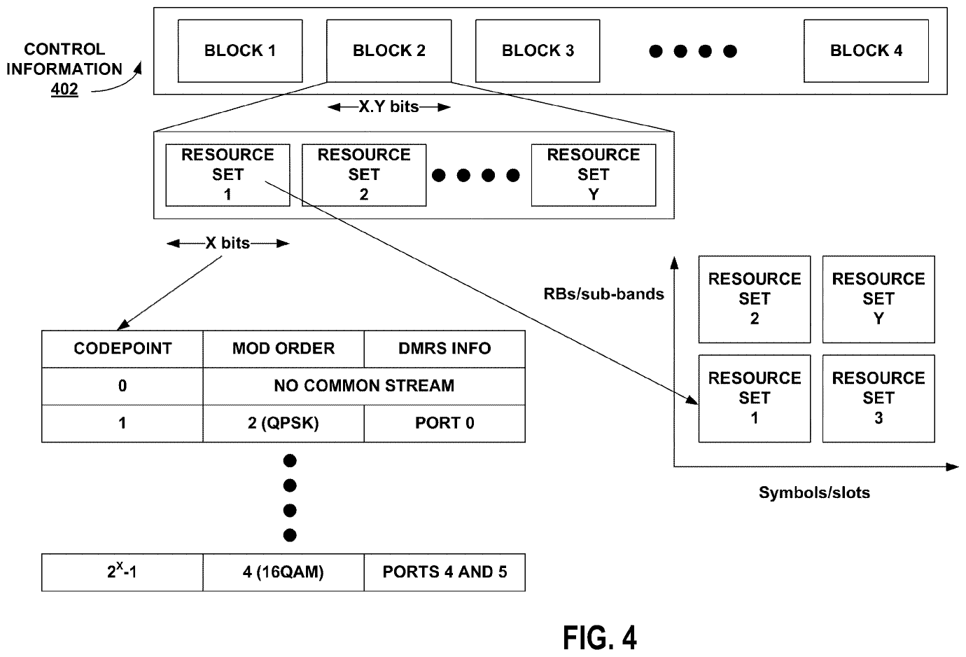

FIG. 4 illustrates an example of control information that indicates resource sets and codepoints for joint demodulation of common and private streams. As illustrated, control information 402 (e.g., which is an example of a GC-DCI message) includes a plurality of blocks labeled as block 1 to block 4. In one or more examples, each of the UEs may be configured (e.g., by RRC messages) with starting locations for one or more of block 1 to block 4. Also, each of the UEs may be configured with the overall payload size of control information 402 (e.g., overall payload size of the GC-DCI).

For purposes of illustration, the contents of block 2 are illustrated in further detail. As illustrated, block 2 indicates resource set 1 to resource set Y. For instance, resource set 1 may correspond to the first X bits of block 2. The first X bits may be for a first common stream. The first X bits of block 2 may represent a codepoint value. The codepoint value may be indicative of parameters for the first common stream. For instance, as illustrated, if the codepoint value is 1, then the modulation order is 2 (QPSK) and the DMRS information is port 0 for the first common stream. If the codepoint value is 2^{X}−1, then the modulation order is 4 (16 QAM) and the DMRS information is ports 4 and 5 for the first common stream. The codepoint value of 0 may indicate that an absence of a common stream.

As noted above, the first X bits may be for the first common stream, and the ordering of the X bits may indicate to which common stream resource set the first common stream corresponds. For instance, in FIG. 4, the first common stream corresponds to common stream resource set 1. The second X bits may be for a second common stream. In this case, the second common stream may correspond to common stream resource set 2, and so forth until common stream resource set Y. In the example, where codepoint value is 0, the parameter may indicate an absence of a common stream for a corresponding common stream resource set. The time-domain (slot, symbol, etc.) and the frequency-domain (bands/sub-bands/RBs) resources for common stream resource sets 1 to Y may be output to the UEs through some form of side communication. For example, a radio resource control (RRC) signal defines the one or more common stream resource sets.

In this way, control information 402 may include information indicative of parameters related to one or more common streams. For example, the first X bits of a block in control information 402 (e.g., a codepoint value) is indicative of parameters related to a first common stream, the second X bits of a block in control information 402 (e.g., another codepoint value) is indicative of parameters related to a second common stream, and so forth.

The one or more common streams may each correspond to one or more common stream resource sets. For example, the first common stream may correspond to common stream resource set 1, the second common stream may correspond to common stream resource set 2, and so forth. The one or more common streams include at least a partial message for at least one UE. For instance, as described such as in FIG. 2, the common stream may be H2PCXC that UE 208B receives. In this example, XC may include at least a partial message for UE 208A.

In one or more examples, the term “partial message” may refer to a portion of a codeword or transport block for a particular UE. For example, in FIG. 2, and as described above, XC may include a partial message for UE 208A, and X1 may also be a message for UE 208A. In one or more examples, XC and X1 may refer to modulated data symbols (e.g., after encoding) and may correspond to the same codeword or transport block. That is, one message may be split, and part of that message may form X1 (e.g., a private stream for UE 208A) and other part of the message may form XC (e.g., a partial message) for UE 208A.

As illustrated in FIG. 4, the common stream resource sets 1 to Y are defined by at least one of a non-overlapping frequency domain or non-overlapping time domain resources. Because common stream resource sets 1 to Y are not overlapping, the UEs may be configured to utilize only the overlapping portions between the PDSCH resource set assigned to the UE (e.g., through a unicast DCI to the UE) and the common stream resource sets 1 to Y for joint demodulation.

The following describes examples with respect to UE 208A and UE 208B of FIG. 2, where the common stream includes a partial message for at least UE 208A, and does not include a message for UE 208B. However, UE 208B may utilize the common stream for joint demodulation of the private stream for UE 208B.

In one or more examples, UE 208B may be scheduled with a PDSCH resource set (e.g., containing the private stream scheduled by a unicast DCI). UE 208B may determine the common stream resource set that partially or fully overlaps the PDSCH resource set. For instance, UE 208B may perform channel estimation corresponding to the layers associated with the common stream (e.g., based on the parameters, such as DMRS ports, indicated by the codepoint values). UE 208B may jointly demodulate the common stream (e.g., based on the parameters, such as modulation order, indicated by the codepoint values) together with the second private stream that is specific to UE 208B (e.g., using the parameters indicated by the unicast DCI). UE 208A may similarly jointly demodulate the common stream together with the first private stream that is specific to UE 208A. However, UE 208A may also decode the common stream since the common stream includes at least a partial message for UE 208A.

For instance, control information 402 includes information indicative of parameters related to one or more common streams. The one or more common streams each correspond to one or more common stream resource sets, and the one or more common streams include at least a partial message for at least one user equipment (UE).

UE 208B may jointly demodulate at least one common stream of the one or more common streams and the private stream based on parameters related to the at least one common stream that corresponds to the common stream resource set to generate at least one demodulated common stream and demodulated private stream. For example, the first common stream may correspond to common stream resource set 1, the second common stream may correspond to common stream resource set 2, and so forth.

Assume that UE 208B determined that common stream resource set 1 from the one or more common stream resource sets because common stream resource set 1 partially or fully overlaps the PDSCH resource set for UE 208B. That is, UE 208B may determine which one of the common stream resource sets at least partially overlaps the PDSCH resource set, and select the common stream resource set based on which one of the common stream resource sets at least partially overlaps the PDSCH resource set. In this example, UE 208B may select common stream resource set 1 based on common stream resource set 1 partially or fully overlapping the PDSCH resource set for UE 208B.

In this example, the first common stream of the one or more common streams may correspond to common stream resource set 1. Therefore, UE 208B may determine the parameters related to the at least one common stream (e.g., the first common stream) that corresponds to the common stream resource set (e.g., common stream resource set 1). For instance, UE 208B may determine the codepoint (e.g., first X bits in block 2), and from the codepoint determine the parameters for the first common stream (e.g., modulation order and DMRS information).

UE 208B may then jointly demodulate at least one common stream (e.g., the first common stream) of the one or more common streams and the private stream based on parameters related to the at least one common stream that corresponds to the common stream resource set (e.g., common stream resource set 1). The result of the joint demodulation may be at least one demodulated common stream and demodulated private stream. UE 208B may decode the private stream based on the demodulated private stream.

In this example, the common stream (e.g., at least one common stream of the one or more common streams) does not include information for UE 208B. As one example, UE 208B may determine that the common stream does not include information intended for UE 208B. For instance, if the unicast DCI scheduling the PDSCH resource set for UE 208B does not include parameters for the common stream, UE 208B may determine that the common stream is not intended for UE 208B. In this example, UE 208B may only consider the overlapping part between the PDSCH resource set for UE 208B and the common stream resource set associated with the common stream. UE 208B may then decode the second private stream using the demodulated private stream.

As another example, UE 208A may determine that the common stream does include information intended for UE 208A. For example, the unicast DCI scheduling the PDSCH resource set may also include parameters related to the common stream. In this example, UE 208A may use the information from the unicast DCI scheduling to validate the parameters related to the common stream. For example, the UE 208A may compare the parameters retrieved for control information 402 (e.g., GC-DCI) with the parameters received from the unicast DCI. If the parameters are the same, then UE 208A may determine that the common stream is intended for UE 208A. UE 208A may utilize the parameters related to the common stream from the unicast DCI and ignore the parameters related to the common stream from control information 402, or vice-versa.

In some examples, it may be possible for the unicast DCI scheduling the PDSCH resource set does not indicate the parameters related to the common stream. However, the unicast DCI scheduling the PDSCH resource set may still include information that UE 208A can utilize to determine that the common stream is intended for UE 208A (e.g., includes partial message for UE 208A).

In one or more examples, UE 208B may perform such operations for each of the common streams. For instance, UE 208B may then proceed with the next X bits for the next common stream resource set. However, if the next common stream resource set does not overlap the PDSCH resource set for UE 208, then UE 208B may not utilize the codepoint value indicated by the next X bits to determine parameters for a common stream.

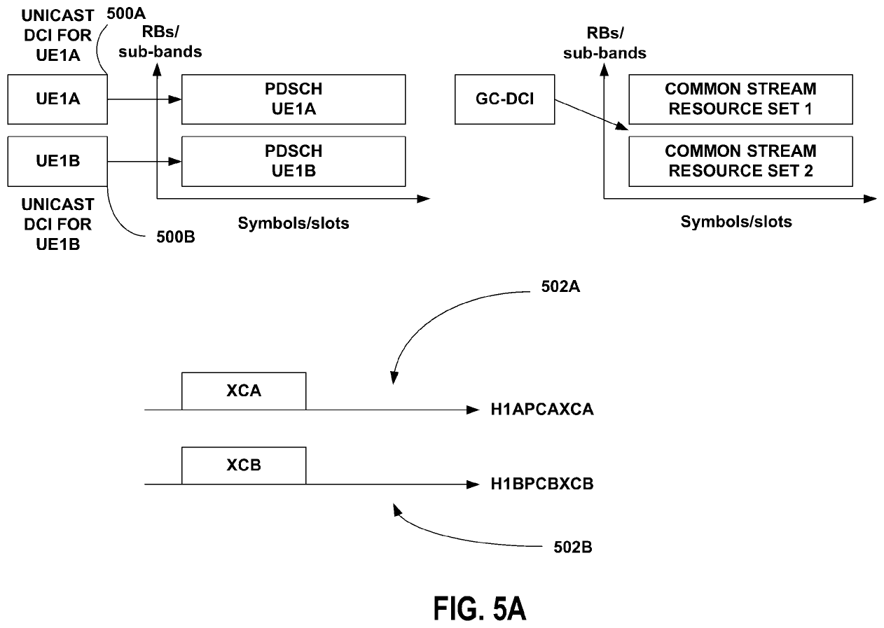

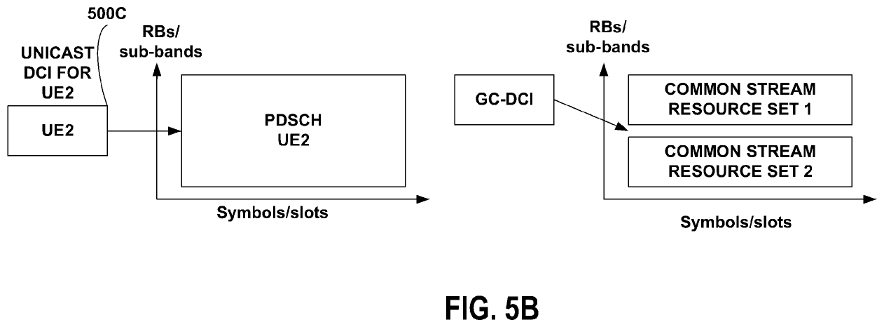

FIGS. 5A and 5B illustrate examples of overlapping resource sets that UEs access. FIG. 5A illustrates first common stream 502A for UE1A 500A and includes partial message XCA for UE1A 500A. For example, XCA may be pre-coded and transmitted in the combined stream resulting in first common stream 502A being represented as H1APCAXCA. Similarly, FIG. 5A illustrates second common stream 502B for UE1B 500B and includes partial message XCB for UE1A 500B. For example, XCB may be pre-coded and transmitted in the combined stream resulting in second common stream 502B being represented as H1BPCBXCB.

In FIGS. 5A and 5B, at least partial messages for UE1A 500A and UE1B 500B (e.g., XCA and XCB, respectively) are included in respective common streams (e.g., first common stream 502A for UE1A 500A and second common stream 502B for UE1B 500B). UE2 500C may utilize parameters related to the first common stream 502A and second common stream 502B to jointly demodulate the private stream specific to UE2 500C along with the first common stream 502A and the second common stream 502B.

For instance, in FIG. 5A, for UE1A 500A, the unicast DCI for UE1A 500A may have previously defined the PDSCH resource set UE1A, and for UE1B 500B, the unicast DCI for UE1B 500B may have previously defined the PDSCH resource set UE1B. As illustrated, the PDSCH resource set UE1A and PDSCH resource set UE1B encompass the illustrated frequency-domain (e.g., y-axis) and time-domain (e.g., x-axis) resources. Assume that the GC-DCI message (e.g., control message 402) included X bits for the codepoint value indicative of parameters related to a first common stream associated with common source resource set 1, and included X bits for the codepoint value indicative of parameters related to a second common stream associated with common source set 2. As illustrated, common stream resource set 1 overlaps with PDSCH resource set for UE1A, and common stream resource set 2 overlaps with PDSCH resource set for UE1B.

In FIG. 5A, PDSCH UE1A and PDSCH UE1B are shown on one graph of symbol/slots as x-axis and RBs/sub-bands as y-axis, and common stream resource set 1 and common stream resource set 2 are shown on another graph of symbol/slots as x-axis and RBs/sub-bands as y-axis, for ease. However, PDSCH UE1A and common stream resource set 1 overlap in resources. That is, the area encompassed in the symbol/slots and RBs/sub-bands for PDSCH UE1A is the same area encompassed in the symbol/slots and RBs/sub-bands for common stream resource set 1. Similarly, PDSCH UE1B and common stream resource set 2 overlap in resources. That is, the area encompassed in the symbol/slots and RBs/sub-bands for PDSCH UE1B is the same area encompassed in the symbol/slots and RBs/sub-bands for common stream resource set 2.

In this example, UE1A 500A may determine which one of the common stream resource sets at least partially overlaps the PDSCH resource set for UELA 500A (e.g., common stream resource set 1). UE1A 500A may select the common stream resource set (e.g., common stream resource set 1) based on which one of the common stream resource sets at least partially overlaps the PDSCH resource set. Similarly, UE1B 500B may determine which one of the common stream resource sets at least partially overlaps the PDSCH resource set for UE1B 500B (e.g., common stream resource set 2). UE1B 500B may select the common stream resource set (e.g., common stream resource set 2) based on which one of the common stream resource sets at least partially overlaps the PDSCH resource set.

A first common stream may correspond to (e.g., may be communicated or transmitted with) common stream resource set 1, and a second common stream may correspond to (e.g., may be communicated or transmitted with) common stream resource set 2. Accordingly, UE1A 500A may jointly demodulate at least one common stream (e.g., first common stream) of the one or more common streams and the private stream for UE1A 500A based on parameters related to the at least one common stream (e.g., first common stream) that corresponds to the common stream resource set (e.g., common stream resource set 1) to generate at least one demodulated common stream and demodulated private stream. Similarly, UE1B 500B may jointly demodulate at least one common stream (e.g., second common stream) of the one or more common streams and the private stream for UE1B 500B based on parameters related to the at least one common stream (e.g., second common stream) that corresponds to the common stream resource set (e.g., common stream resource set 2) to generate at least one demodulated common stream and demodulated private stream.

As illustrated in FIG. 5B, for UE2 500C, the unicast DCI for UE2 500C may have previously defined the PDSCH resource set UE2. PDSCH resource set UE2 overlaps both the common stream resource set 1 and the common stream resource set 2. For instance, the symbols/slot and the RB/sub-bands for PDSCH UE2 overlap the symbols/slot and RB-sub-bands for both common stream resource set 1 and common stream resource set 2. In this example, UE2 500C may jointly demodulate the private stream specific to UE2 500C and the first common stream that corresponds to common stream resource set 1, and jointly demodulate the private stream specific to UE2 500C and the second common stream that corresponds to common stream resource set 2. UE2 500C may then decode the private stream using the demodulated private stream.

For instance, UE2 500C may determine which one of the common stream resource sets at least partially overlaps the PDSCH resource set for UE2 500C. In this example, both common stream resource sets 1 and 2. UE2 500C may select the common stream resource set (e.g., both common stream resource sets 1 and 2) based on which one of the common stream resource sets at least partially overlaps the PDSCH resource set for UE2 500C. UE2 500C may jointly demodulate at least one common stream (e.g., both the first common stream and the second common stream) of the one or more common streams and the private stream based on parameters related to the at least one common stream (e.g., parameters for the first common stream and the second common stream) that corresponds to the common stream resource set (e.g., to common stream resource set 1 and common stream resource set 2) to generate at least one demodulated common stream and demodulated private stream.

In FIG. 5B, PDSCH UE2 is shown on one graph of symbol/slots as x-axis and RBs/sub-bands as y-axis, and common stream resource set 1 and common stream resource set 2 are shown on another graph of symbol/slots as x-axis and RBs/sub-bands as y-axis, for ease. However, PDSCH UE2 and common stream resource set 1 overlap in resources. That is, the area encompassed in the symbol/slots and RBs/sub-bands for PDSCH UE2 overlaps the area encompassed in the symbol/slots and RBs/sub-bands for common stream resource set 1. Similarly, PDSCH UE2 and common stream resource set 2 overlap in resources. That is, the area encompassed in the symbol/slots and RBs/sub-bands for PDSCH UE2 overlaps the same area encompassed in the symbol/slots and RBs/sub-bands for common stream resource set 2. In FIG. 5B, PDSCH UE2 overlaps both common stream resource set 1 and common stream resource set 2.

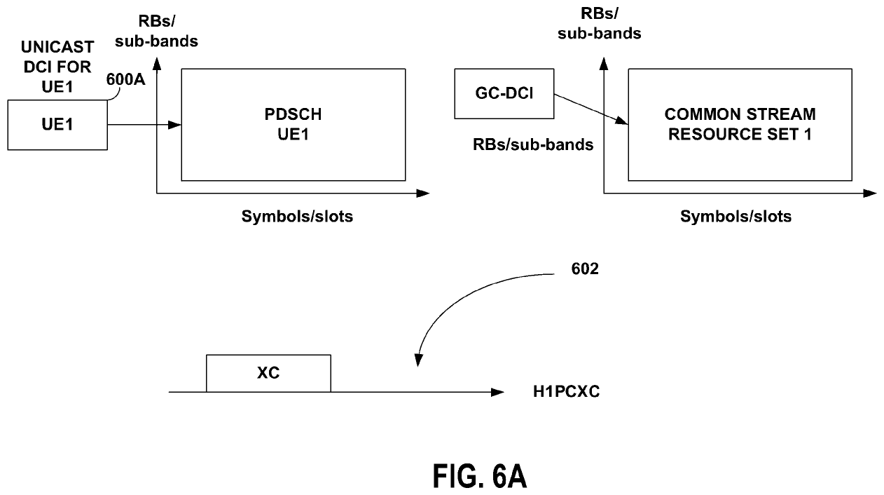

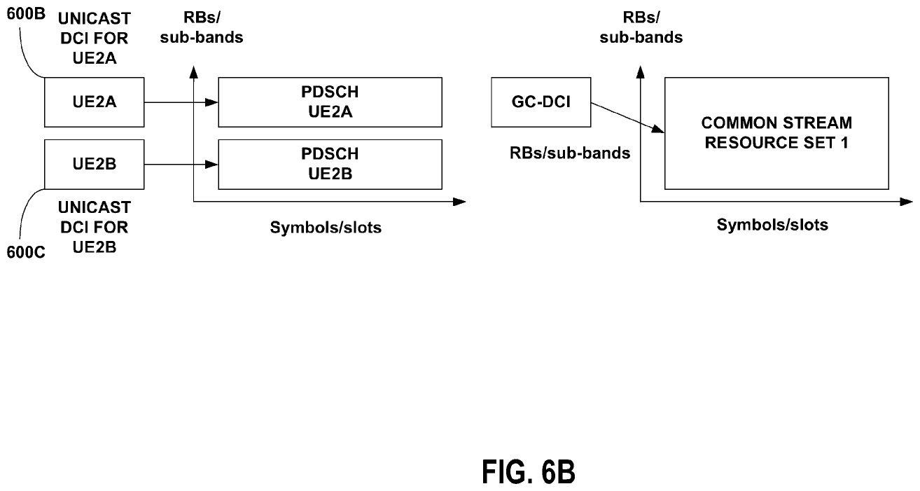

FIGS. 6A and 6B illustrate additional examples of overlapping resource sets that UEs access. FIG. 6A illustrates common stream 602 for UE1 600A and includes partial message XC for UE1 600A. For example, XC may be pre-coded and transmitted in the combined stream resulting in common stream 602 being represented as H1PCXC. In FIGS. 6A and 6B, at least partial messages for UE1 600A (e.g., XC) is included in a common stream 602. UE2A 600B and UE2B 600C may utilize parameters related to the common stream 602 to jointly demodulate the private stream specific to UE2A 600B and the private stream specific to UE2B 600C along with the common stream 602.

For instance, in FIG. 6A, for UE1 600A, the unicast DCI for UE1 600A may have previously defined the PDSCH resource set UE1. As illustrated, the PDSCH resource set UE1 encompass the illustrated frequency-domain (e.g., y-axis) and time-domain (e.g., X-axis) resources. Assume that the GC-DCI message (e.g., control message 402) included X bits for the codepoint value indicative of parameters related to a common stream associated with common source resource set 1. As illustrated, common stream resource set 1 overlaps with PDSCH resource set for UE1.

In FIG. 6A, PDSCH UE1 is shown on one graph of symbol/slots as x-axis and RBs/sub-bands as y-axis, and common stream resource set 1 is shown on another graph of symbol/slots as x-axis and RBs/sub-bands as y-axis, for ease. However, PDSCH UE1 and common stream resource set 1 overlap in resources. That is, the area encompassed in the symbol/slots and RBs/sub-bands for PDSCH UE1 is the same area encompassed in the symbol/slots and RBs/sub-bands for common stream resource set 1.

As illustrated in FIG. 6B, for UE2A 600B, the unicast DCI for UE2A 600B may have defined the PDSCH resource set UE2A, and for UE2B 600C, the unicast DCI for UE2B 600C may have defined the PDSCH resource set UE2B. As illustrated, the PDSCH resource set UE2A and PDSCH resource set UE2B encompass the illustrated frequency-domain (e.g., y-axis) and time-domain (e.g., x-axis) resources. In FIG. 6B, PDSCH resource set UE2A partially overlaps common stream resource set 1, and PDSCH resource set UE2B partially overlaps common stream resource set 1. For instance, the symbols/slot and the RB/sub-bands for PDSCH UE2A and the symbols/slot and the RB/sub-bands for PDSCH UE2B each partially overlap the symbols/slot and RB-sub-bands for common stream resource set 1.

In FIG. 6B, PDSCH UE2A and PDSCH UE2B are shown on one graph of symbol/slots as x-axis and RBs/sub-bands as y-axis, and common stream resource set 1 is shown on another graph of symbol/slots as x-axis and RBs/sub-bands as y-axis, for ease. However, PDSCH UE2A and common stream resource set 1 overlap in resources. That is, the area encompassed in the symbol/slots and RBs/sub-bands for PDSCH UE2A is the same area partially encompassed in the symbol/slots and RBs/sub-bands for common stream resource set 1. Similarly, PDSCH UE2B and common stream resource set 1 overlap in resources. That is, the area encompassed in the symbol/slots and RBs/sub-bands for PDSCH UE2B is the same area partially encompassed in the symbol/slots and RBs/sub-bands for common stream resource set 1.

In this example, UE2A 600B may jointly demodulate the private stream specific to UE2A 600B and the overlapping portion of the common stream that corresponds to (e.g., may be communicated or transmitted with) common stream resource set 1, and UE2B 600C may jointly demodulate the private stream specific to UE2B 600C and the overlapping portion of the common stream that corresponds to (e.g., may be communicated or transmitted with) common stream resource set 1. UE2A 600B may then decode the private stream for UE2A 600B using the demodulated private stream for UE2A 600B, and UE2B 600C may then decode the private stream for UE2B 600C using the demodulated private stream for UE2B 600C.

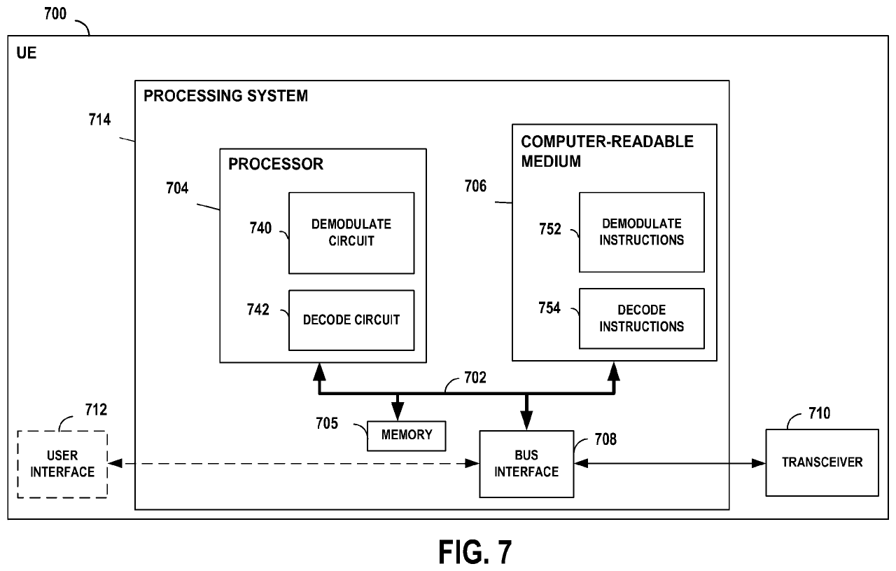

FIG. 7 is a block diagram illustrating an example of a hardware implementation for a UE according to some aspects of this disclosure. For example, the UE 700 may be a UE 115, 208A, 208B, or any of the UEs as illustrated in any one or more of FIGS. 1-3 and 5A-6B.

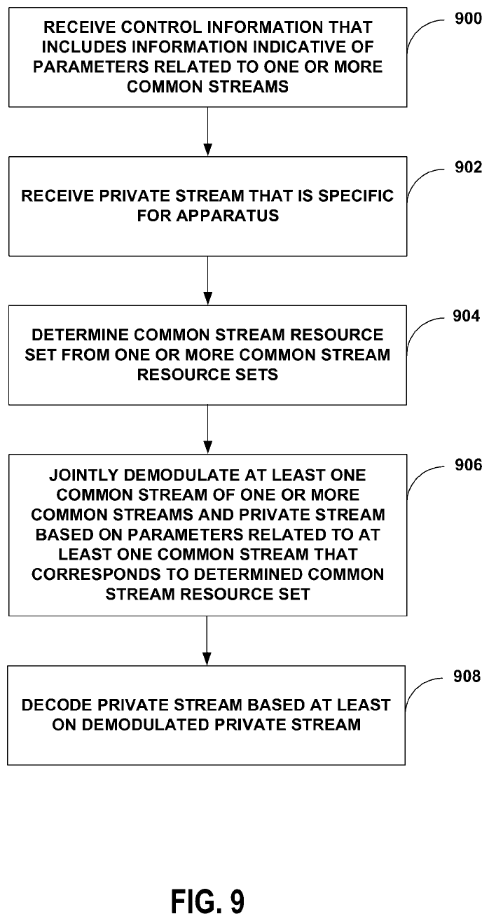

The UE 700 may include a processing system 714 having one or more processors 704. Examples of processors 704 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 700 may be configured to perform any one or more of the functions described herein. For example, the processor 704, as utilized in a UE 700, may be configured (e.g., in coordination with the memory 705) to implement any one or more of the processes and procedures described above and illustrated below in FIG. 9.

The processing system 714 may be implemented with a bus architecture, represented generally by the bus 702. The bus 702 may include any number of interconnecting buses and bridges depending on the specific application of the processing system 714 and the overall design constraints. The bus 702 communicatively couples together various circuits including one or more processors (represented generally by the processor 704), a memory 705, and computer-readable media (represented generally by the computer-readable medium 706). The bus 702 may also link various other circuits such as timing sources, peripherals, voltage regulators, and power management circuits, which are well known in the art, and therefore, will not be described any further. A bus interface 708 provides an interface between the bus 702 and a transceiver 710. The transceiver 710 provides a communication interface or means for communicating with various other apparatus over a transmission medium. Depending upon the nature of the apparatus, a user interface 712 (e.g., keypad, display, speaker, microphone, joystick) may also be provided. Of course, such a user interface 712 is optional, and some examples, such as a base station, may omit it.

In some aspects of the disclosure, the processor 704 may include a demodulate circuit 740 and a decode circuit 742 configured (e.g., in coordination with the memory 705) for various functions. As one example, processor 704 may receive control information that includes information indicative of parameters related to one or more common streams. The one or more common streams each correspond to one or more common stream resource sets, and the one or more common streams include at least a partial message for at least one UE.

For instance, processor 704 may receive control information 402 that includes blocks, and each block includes X bits to indicate parameters related to the one or more common streams. Control information 402 is an example of a GC-DCI signal. In some examples, the GC-DCI signal includes a layerSplit-RNTI.

The one or more parameters include modulation order, demodulation reference signal (DMRS) port number, and DMRS sequence. The information indicative of parameters may be a codepoint value (e.g., as illustrated in FIG. 4), and processor 704 may be configured to determine the parameters based on the codepoint value. For example, memory 705 may store a lookup table that maps the codepoint value to parameters related to respective common streams.

The one or more common stream resource sets may be defined by at least one of a non-overlapping frequency domain or non-overlapping time domain resources, as illustrated in FIGS. 4, 5A, 5B, 6A, and 6B as a few examples. UE 700 may receive a RRC signal that defines the one or more common stream resource sets (e.g., the frequency domain and time-domain information for the common stream resource sets).

Processor 704 may also receive a private stream that is specific for UE 700. In some examples, the one or more common streams are in a first one or more layers, and the private stream is in a second one or more layers

Processor 704 may determine a common stream resource set from the one or more common stream resource sets. For example, processor 704 may determine a PDSCH resource set assigned to UE 700. For instance, a unicast message to UE 700 that scheduled the PDSCH resource set includes the private stream that is specific for UE 700. In some examples, to determine the common stream resource set, processor 704 may be configured to determine which one of the common stream resource sets at least partially overlaps the PDSCH resource set, and select the common stream resource set based on the determination.

Demodulate circuit 740 may jointly demodulate at least one common stream of the one or more common streams and the private stream based on the parameters related to the at least one common stream that corresponds to the common stream resource set (e.g., the determined common stream resource set) to generate at least one demodulated common stream and demodulated private stream. For instance, demodulate circuit 740 may determine an overlapping resource set that includes overlapping portion of the PDSCH resource set and the common stream resource set. To joint demodulate, demodulate circuit 740 may jointly demodulate the at least one common stream of the one or more common streams that correspond to the overlapping resource set and the private stream based on the parameters (e.g., as illustrated in FIGS. 5A, 5B, 6A, and 6B).

Decode circuit 742 may decode the private stream based at least on the demodulated private stream. In some examples, decode circuit 742 may decode the private stream based at least on the demodulated private stream and without the at least one common stream. For instance, if the common stream is not intended for UE 700, then decode circuit 742 may not decode the common stream. Processor 704 may be configured to determine that at least one of the common streams of the one or more common streams is not for UE 700. For example, processor 704 may determine that a unicast scheduling message does not include parameters related to the at least one common stream. The unicast scheduling message may indicate to UE 700 that the messages for the at least one common stream are not intended for UE 700.

The processor 704 is responsible for managing the bus 702 and general processing, including the execution of software stored on the computer-readable medium 706. The software, when executed by the processor 704, causes the processing system 714 to perform the various functions described above for any particular apparatus. The processor 704 may also use the computer-readable medium 706 and the memory 705 for storing data that the processor 704 manipulates when executing software.

One or more processors 704 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 706. The computer-readable medium 706 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 706 may reside in the processing system 714, external to the processing system 714, or distributed across multiple entities including the processing system 714. The computer-readable medium 706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable medium 706 may store computer-executable code that includes demodulate instructions 752 and decode instructions 754 configured for various functions. For instance, demodulate instructions 752 and decode instructions 754, when executed by processor 704, may cause processor 704 to perform the example features described for demodulate circuit 740 and decode circuit 742, respectively.

Of course, in the above examples, the circuitry included in the processor 704 is merely provided as an example, and other means for carrying out the described functions may be included within various aspects of the present disclosure, including but not limited to the instructions stored in the computer-readable medium 706, or any other suitable apparatus or means described in any one of the figures, and utilizing, for example, the processes and/or algorithms described above and described below in relation to FIG. 9.

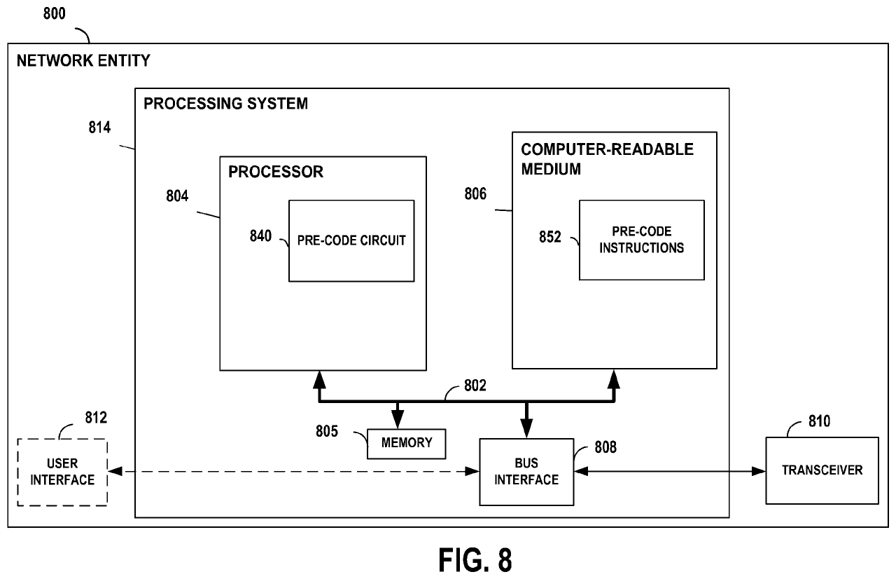

FIG. 8 is a conceptual diagram illustrating an example of a hardware implementation for an exemplary network entity (e.g., a gNB or base station) 800 according to some aspects of this disclosure. In accordance with various aspects of the disclosure, a processing system 814 may include an element, or any portion of an element, or any combination of elements having one or more processors 804. For example, the network entity 800 may be network entity 105 or network entity 200 as illustrated in FIGS. 1 and 2.

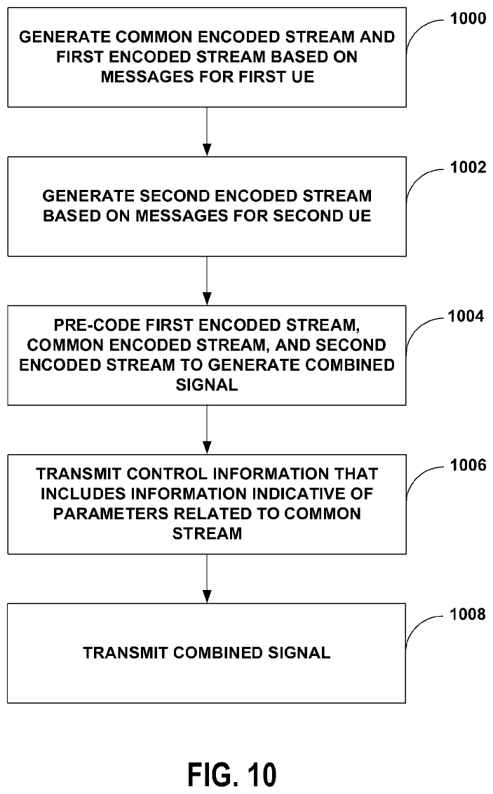

The processing system 814 may be substantially the same as the processing system 714 illustrated in FIG. 7, including a bus interface 808, a bus 802, memory 805, a processor 804, and a computer-readable medium 806. Furthermore, the network entity 800 may include a user interface 812 and a transceiver 810 substantially similar to those described above in FIG. 7. That is, the processor 804, as utilized in the network entity 800, may be configured (e.g., in coordination with the memory 805) to implement any one or more of the processes described above and illustrated in FIG. 10.

In some aspects of the disclosure, the processor 804 may include a pre-code circuit 840 configured (e.g., in coordination with the memory 805) for various functions. For example, processor 804 may be configured to generate a common encoded stream and a first encoded stream based on messages for a first UE. Processor 804 may generate a second encoded stream based on messages for a second UE. For example, as illustrated in FIG. 2, encoder 202A may receive messages W1 for UE 208A and generate common encoded stream (XC) and generate first encoded stream (X1). Encoder 202B may receive messages W2 for UE 208B and generate second encoded stream (X2).

Pre-code circuit 840 may be configured to pre-code the first encoded stream, the common encoded stream, and the second encoded stream to generate a combined signal that is to be received by the first UE and the second UE. The combined signal includes a first private stream based on the first encoded stream, a common stream based on the common encoded stream, and a second private stream based on the second encoded stream. For instance, as illustrated in FIG. 2, UE 208A and UE 208B each receive the combined signal. Pre-code circuit 840 may select the pre-coding parameters as described above with respect to FIG. 2.

For example, UE 208A, as illustrated in FIG. 2, may receive Y1, which includes the first private stream (H1P1X1) that is generated based on first encoded stream (X1), common stream (H1PCXC) that is generated based on common encoded stream (XC), and the second private stream (H1P2X2) that is generated based on second encoded stream (X2). However, the signal strength of H1P2X2 may be relatively small. Similarly, UE 208B, as illustrated in FIG. 2, may receive Y2, which includes the first private stream (H2P1X1) that is generated based on first encoded stream (X1), common stream (H2PCXC) that is generated based on common encoded stream (XC), and the second private stream (H2P2X2) that is generated based on second encoded stream (X2). However, the signal strength of H2P1X1 may be relatively small.

Processor 804 may be configured to transmit control information that includes information indicative of parameters related to the common stream. As described, the one or more common streams each correspond to one or more common stream resource sets. The information indicative of parameters may include a codepoint value that is an index into a table that includes the one or more parameters (e.g., such as the lookup table illustrated in FIG. 4). Processor 804 may also transmit the combined signal.

In some examples, processor 804 may transmit a unicast scheduling message to the first UE that includes the parameters related to the common stream. This way, if the first UE determines that the parameters in the unicast scheduling message are the same as the parameters determined from the control information 402, the first UE may determine that the common stream includes messages for the first UE.

In one or more examples, the computer-readable medium 806 may store computer-executable code that includes pre-code instructions 852. For example, processor 804 executing pre-code instructions 852 may cause processor 804 to perform the techniques described for pre-code circuit 840.

Of course, in the above examples, the circuitry included in the processor 804 is merely provided as an example, and other means for carrying out the described functions may be included within various aspects of the present disclosure, including but not limited to the instructions stored in the computer-readable medium 806, or any other suitable apparatus or means described in any one of the figures, and utilizing, for example, the processes and/or algorithms described above and below in relation to FIG. 10.

FIG. 9 is a flowchart illustrating an example method of processing a wireless communication for layer splitting. For ease of description, the example is described with respect to UE 208B of FIG. 2. However, the example techniques may be performed by other example UEs described above.

UE 208B may receive control information that includes information indicative of parameters related to one or more common streams (900). The one or more common streams each correspond to one or more common stream resource sets, and the one or more common streams include at least a partial message for at least one UE.

For instance, UE 208B may receive control information 402 of FIG. 4 that includes blocks, and each block includes X bits to indicate parameters related to the one or more common streams. Control information 402 is an example of a GC-DCI signal. In some examples, the GC-DCI signal includes a layerSplit-RNTI.

The one or more parameters include modulation order, demodulation reference signal (DMRS) port number, and DMRS sequence. The information indicative of parameters may be a codepoint value (e.g., as illustrated in FIG. 4), and UE 208B may be configured to determine the parameters based on the codepoint value. For example, a memory of UE 208B may store a lookup table that maps the codepoint value to parameters related to respective common streams. UE 208B may utilize the codepoint value as an index into the lookup table, and determine the parameters from the lookup table.

The one or more common stream resource sets may be defined by at least one of a non-overlapping frequency domain or non-overlapping time domain resources, as illustrated in FIGS. 4, 5A, 5B, 6A, and 6B as a few examples. In some examples, UE 208B may receive a RRC signal that defines the one or more common stream resource sets (e.g., the frequency-domain and time-domain information for the common stream resource sets).

UE 208B may also receive a private stream that is specific for UE 208B (902). For instance, as illustrated in FIG. 2, the second private stream (H2P2X2) is received by UE 208B as part of the combined signal. In some examples, the one or more common streams are in a first one or more layers, and the private stream is in a second one or more layers

UE 208B may determine a common stream resource set from the one or more common stream resource sets (904). For example, UE 208B may determine a PDSCH resource set assigned to UE 208B. For instance, a unicast message to UE 208B that scheduled the PDSCH resource set includes the private stream that is specific for UE 208B. In some examples, to determine the common stream resource set, UE 208B may be configured to determine which one of the common stream resource sets at least partially overlaps the PDSCH resource set, and select the common stream resource set based on the determination.

UE 208B may jointly demodulate at least one common stream of the one or more common streams and the private stream based on the parameters related to the at least one common stream that corresponds to to the common stream resource set (e.g., the determined common stream resource set) to generate at least one demodulated common stream and demodulated private stream (906). For instance, UE 208B may determine an overlapping resource set that includes overlapping portion of the PDSCH resource set and the common stream resource set. To joint demodulate, UE 208B may jointly demodulate the at least one common stream of the one or more common streams that corresponds to the overlapping resource set and the private stream based on the parameters (e.g., as illustrated in FIGS. 5A, 5B, 6A, and 6B).

UE 208B may decode the private stream based at least on the demodulated private stream (908). In some examples, UE 208B may decode the private stream based at least on the demodulated private stream and without the at least one common stream. For instance, if the common stream is not intended for UE 208B, then UE 208B may not decode the common stream. UE 208B may be configured to determine that at least one of the common streams of the one or more common streams is not for UE 208B. For example, UE 208B may determine that a unicast scheduling message does not include parameters related to the at least one common stream. The unicast scheduling message may indicate to UE 208B that the messages for the at least one common stream are not intended for UE 208B.

FIG. 10 is a flowchart illustrating an example method of transmitting wireless communication for layer splitting. For ease of of description, the example is described with respect to network entity 200 of FIG. 2. However, the example techniques may be performed by other example network entities described above.

Network entity 200 may be configured to generate a common encoded stream and a first encoded stream based on messages for a first UE 208A (1000). Network entity 200 may generate a second encoded stream based on messages for a second UE 208B (1002). For example, as illustrated in FIG. 2, encoder 202A may receive messages W1 for UE 208A and generate common encoded stream (XC) and generate first encoded stream (X1). Encoder 202B may receive messages W2 for UE 208B and generate second encoded stream (X2).

Network entity 200 may be configured to pre-code the first encoded stream, the common encoded stream, and the second encoded stream to generate a combined signal that is to be received by the first UE and the second UE (1004). The combined signal includes a first private stream based on the first encoded stream, a common stream based on the common encoded stream, and a second private stream based on the second encoded stream. For instance, as illustrated in FIG. 2, UE 208A and UE 208B each receive the combined signal. Network entity 200 may select the pre-coding parameters as described above with respect to FIG. 2.

For example, UE 208A, as illustrated in FIG. 2, may receive Y1, which includes the first private stream (H1P1X1) that is generated based on first encoded stream (X1), common stream (H1PCXC) that is generated based on common encoded stream (XC), and the second private stream (H1P2X2) that is generated based on second encoded stream (X2). However, the signal strength of H1P2X2 may be relatively small. Similarly, UE 208B, as illustrated in FIG. 2, may receive Y2, which includes the first private stream (H2P1X1) that is generated based on first encoded stream (X1), common stream (H2PCXC) that is generated based on common encoded stream (XC), and the second private stream (H2P2X2) that is generated based on second encoded stream (X2). However, the signal strength of H2P1X1 may be relatively small.

Network entity 200 may be configured to transmit control information that includes information indicative of parameters related to the common stream (1006). As described, the one or more common streams each correspond to one or more common stream resource sets. The information indicative of parameters may include a codepoint value that is an index into a table that includes the one or more parameters (e.g., such as the lookup table illustrated in FIG. 4). Network entity 200 may also transmit the combined signal. (1008) In some examples, network entity 200 may transmit a unicast scheduling message to the first UE that includes the parameters related to the common stream. This way, if the first UE determines that the parameters in the unicast scheduling message are the same as the parameters determined from the control information 402, the first UE may determine that the common stream includes messages for the first UE.

The following numbered clauses illustrate one or more aspects of the devices and techniques described in this disclosure.

Clause 1. An apparatus for wireless communication, comprising: a memory; and a processor coupled to the memory and configured to: receive control information that includes information indicative of parameters related to one or more common streams, wherein the one or more common streams each correspond to one or more common stream resource sets, and wherein the one or more common streams include at least a partial message for at least one user equipment (UE); receive a private stream that is specific for the apparatus; determine a common stream resource set from the one or more common stream resource sets; jointly demodulate at least one common stream of the one or more common streams and the private stream based on parameters related to the at least one common stream that corresponds to the common stream resource set to generate at least one demodulated common stream and demodulated private stream; and decode the private stream based at least on the demodulated private stream.

Clause 2. The apparatus of clause 1, wherein the processor is configured to: determine a physical downlink shared channel (PDSCH) resource set, wherein a unicast message to the apparatus that scheduled the PDSCH resource set includes the private stream that is specific for the apparatus, wherein to determine the common stream resource set, the processor is configured to: determine which one of the common stream resource sets at least partially overlaps the PDSCH resource set; and select the common stream resource set based on which one of the common stream resource sets at least partially overlaps the PDSCH resource set.

Clause 3. The apparatus of clause 2, wherein the processor is configured to: determine an overlapping resource set that includes overlapping portion of the PDSCH resource set and the common stream resource set, wherein to jointly demodulate, the processor is configured to jointly demodulate the at least one common stream that corresponds to the overlapping resource set and the private stream based on the parameters related to the at least one common stream that corresponds to the common stream resource set.

Clause 4. The apparatus of any of clauses 1-3, wherein to decode the private stream, the processor is configured to decode the private stream based at least on the demodulated private stream and without the at least one common stream.

Clause 5. The apparatus of any of clauses 1-4, wherein the processor is configured to: determine that the at least one common stream of the one or more common streams is not for the apparatus.

Clause 6. The apparatus of clause 5, wherein to determine that the at least one common stream is not for the apparatus, the processor is configured to: determine that a unicast scheduling message does not include the parameters related to the at least one common stream.

Clause 7. The apparatus of any of clauses 1-6, wherein the one or more common streams are in a first one or more layers, and wherein the private stream is in a second one or more layers.

Clause 8. The apparatus of any of clauses 1-7, wherein the parameters related to the at least one common stream include modulation order, demodulation reference signal (DMRS) port number, and DMRS sequence.

Clause 9. The apparatus of any of clauses 1-8, wherein the information indicative of parameters comprises a codepoint value, and wherein the processor is configured to determine the parameters based on the codepoint value.

Clause 10. The apparatus of any of clauses 1-9, wherein the one or more common stream resource sets are defined by at least one of a non-overlapping frequency domain or non-overlapping time domain resources.

Clause 11. The apparatus of any of clauses 1-10, wherein a radio resource control (RRC) signal defines the one or more common stream resource sets.

Clause 12. The apparatus of any of clauses 1-11, wherein the control information is a group common downlink control information (GC-DCI) signal.

Clause 13. The apparatus of clause 12, wherein the GC-DCI signal includes a layer split radio network temporary identifier (layerSplit-RNTI).

Clause 14. A system for wireless communication, comprising: a memory; and a processor coupled to the memory and configured to: generate a common encoded stream and a first encoded stream based on messages for a first user equipment (UE); generate a second encoded stream based on messages for a second UE; pre-code the first encoded stream, the common encoded stream, and the second encoded stream to generate a combined signal that is to be received by the first UE and the second UE, the combined signal including a first private stream based on the first encoded stream, a common stream based on the common encoded stream, and a second private stream based on the second encoded stream; transmit control information that includes information indicative of parameters related to the common stream, wherein the common stream corresponds to one or more common stream resource sets; and transmit the combined signal.

Clause 15. The system of clause 14, wherein the processor is configured to: transmit a unicast scheduling message to the first UE that includes the parameters of the common stream.

Clause 16. The system of any of clauses 14 and 15, wherein the common stream is in a first one or more layers, and wherein the first private stream or the second private stream is in a second one or more layers.

Clause 17. The system of any of clauses 14-16, wherein the parameters include modulation order and demodulation reference signal (DMRS) port number, and DMRS sequence.

Clause 18. The system of any of clauses 14-17, wherein the information indicative of parameters comprises a codepoint value that is an index into a table that includes the one or more parameters.

Clause 19. The system of any of clauses 14-18, wherein the at least on common stream resource set is defined by at least one of a non-overlapping frequency domain or non-overlapping time domain resources.

Clause 20. The system of any of clauses 14-19, wherein a radio resource control (RRC) signal defines the one or more common stream resource sets.

Clause 21. The system of any of clauses 14-20, wherein the control information is a group common downlink control information (GC-DCI) signal.

Clause 22. The system of clause 21, wherein the GC-DCI signal includes a layer split radio network temporary identifier (layerSplit-RNTI).

Clause 23. A method of processing wireless communication, comprising: receiving, with an apparatus, control information that includes information indicative of parameters related to one or more common streams, wherein the one or more common streams each correspond to one or more common stream resource sets, and wherein the one or more common streams include at least a partial message for at least one user equipment (UE); receiving a private stream that is specific for the apparatus; determining a common stream resource set from the one or more common stream resource sets; jointly demodulating at least one common stream of the one or more common streams and the private stream based on parameters related to the at least common stream that corresponds to the common stream resource set to generate at least one demodulated common stream and demodulated private stream; and decoding the private stream based at least on the demodulated private stream.

Clause 24. The method of clause 23, further comprising: determining a physical downlink shared channel (PDSCH) resource set, wherein a unicast message to the apparatus that scheduled the PDSCH resource set includes the private stream that is specific for the apparatus, wherein determining the common stream resource set comprises: determining which one of the common stream resource sets at least partially overlaps the PDSCH resource set; and selecting the common stream resource set based on which one of the common stream resource sets at least partially overlaps the PDSCH resource set.

Clause 25. The method of clause 24, further comprising: determining an overlapping resource set that includes overlapping portion of the PDSCH resource set and the common stream resource set, wherein jointly demodulating comprises jointly demodulating the at least one common stream that corresponds to the overlapping resource set and the private stream based on the parameters related to the at least one common stream that corresponds to the common stream resource set.

Clause 26. The method of any of clauses 23-25, wherein decoding the private stream comprises decoding the private stream based at least on the demodulated private stream and without the at least one common stream.

Clause 27. The method of any of clauses 23-26, wherein the one or more common streams are in a first one or more layers, and wherein the private stream is in a second one or more layers.

Clause 28. The method of any of clauses 23-27, wherein the parameters related to the at least one common stream include modulation order, demodulation reference signal (DMRS) port number, and DMRS sequence.

Clause 29. The method of any of clauses 23-28, wherein the control information is a group common downlink control information (GC-DCI) signal.

Clause 30. A method of transmitting wireless communication, comprising: generating a common encoded stream and a first encoded stream based on messages for a first user equipment (UE); generating a second encoded stream based on messages for a second UE; pre-coding the first encoded stream, the common encoded stream, and the second encoded stream to generate a combined signal that is to be received by the first UE and the second UE, the combined signal including a first private stream based on the first encoded stream, a common stream based on the common encoded stream, and a second private stream based on the second encoded stream; transmitting control information that includes information indicative of parameters related to the common stream, wherein the common stream corresponds to one or more common stream resource sets; and transmitting the combined signal.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at different locations, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (in other words, A and B and C). Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. An apparatus for wireless communication, comprising:
a memory; and
a processor coupled to the memory and configured to:
receive control information that includes information indicative of parameters related to one or more common streams, wherein the one or more common streams each correspond to one or more common stream resource sets, and wherein the one or more common streams include at least a partial message for at least one user equipment (UE);
receive a private stream that is specific for the apparatus;
determine a common stream resource set from the one or more common stream resource sets;
jointly demodulate at least one common stream of the one or more common streams and the private stream based on parameters related to the at least one common stream that corresponds to the common stream resource set to generate at least one demodulated common stream and demodulated private stream; and
decode the private stream based at least on the demodulated private stream.

2. The apparatus of claim 1, wherein the processor is configured to:
determine a physical downlink shared channel (PDSCH) resource set, wherein a unicast message to the apparatus that scheduled the PDSCH resource set includes the private stream that is specific for the apparatus,
wherein to determine the common stream resource set, the processor is configured to:
determine which one of the common stream resource sets at least partially overlaps the PDSCH resource set; and
select the common stream resource set based on which one of the common stream resource sets at least partially overlaps the PDSCH resource set.

3. The apparatus of claim 2, wherein the processor is configured to:
determine an overlapping resource set that includes overlapping portion of the PDSCH resource set and the common stream resource set,
wherein to jointly demodulate, the processor is configured to jointly demodulate the at least one common stream that corresponds to the overlapping resource set and the private stream based on the parameters related to the at least one common stream that corresponds to the common stream resource set.

4. The apparatus of claim 1, wherein to decode the private stream, the processor is configured to decode the private stream based at least on the demodulated private stream and without the at least one common stream.

5. The apparatus of claim 1, wherein the processor is configured to:
determine that the at least one common stream of the one or more common streams is not for the apparatus.

6. The apparatus of claim 5, wherein to determine that the at least one common stream is not for the apparatus, the processor is configured to:
determine that a unicast scheduling message does not include the parameters related to the at least one common stream.

7. The apparatus of claim 1, wherein the one or more common streams are in a first one or more layers, and wherein the private stream is in a second one or more layers.

8. The apparatus of claim 1, wherein the parameters related to the at least one common stream include modulation order, demodulation reference signal (DMRS) port number, and DMRS sequence.

9. The apparatus of claim 1, wherein the information indicative of parameters comprises a codepoint value, and wherein the processor is configured to determine the parameters based on the codepoint value.

10. The apparatus of claim 1, wherein the one or more common stream resource sets are defined by at least one of a non-overlapping frequency domain or non-overlapping time domain resources.

11. The apparatus of claim 1, wherein a radio resource control (RRC) signal defines the one or more common stream resource sets.

12. The apparatus of claim 1, wherein the control information is a group common downlink control information (GC-DCI) signal.

13. The apparatus of claim 12, wherein the GC-DCI signal includes a layer split radio network temporary identifier (layerSplit-RNTI).

14. A system for wireless communication, comprising:
a memory; and
a processor coupled to the memory and configured to:
generate a common encoded stream and a first encoded stream based on messages for a first user equipment (UE);
generate a second encoded stream based on messages for a second UE;
pre-code the first encoded stream, the common encoded stream, and the second encoded stream to generate a combined signal that is to be received by the first UE and the second UE, the combined signal including a first private stream based on the first encoded stream, a common stream based on the common encoded stream, and a second private stream based on the second encoded stream;
transmit control information that includes information indicative of parameters related to the common stream, wherein the common stream corresponds to one or more common stream resource sets; and
transmit the combined signal.

15. The system of claim 14, wherein the processor is configured to:
transmit a unicast scheduling message to the first UE that includes the parameters of the common stream.

16. The system of claim 14, wherein the common stream is in a first one or more layers, and wherein the first private stream or the second private stream is in a second one or more layers.

17. The system of claim 14, wherein the parameters include modulation order and demodulation reference signal (DMRS) port number, and DMRS sequence.

18. The system of claim 14, wherein the information indicative of parameters comprises a codepoint value that is an index into a table that includes the one or more parameters.

19. The system of claim 14, wherein the at least on common stream resource set is defined by at least one of a non-overlapping frequency domain or non-overlapping time domain resources.

20-22. (canceled)

23. A method of processing wireless communication, comprising:
receiving, with an apparatus, control information that includes information indicative of parameters related to one or more common streams, wherein the one or more common streams each correspond to one or more common stream resource sets, and wherein the one or more common streams include at least a partial message for at least one user equipment (UE);
receiving a private stream that is specific for the apparatus;
determining a common stream resource set from the one or more common stream resource sets;
jointly demodulating at least one common stream of the one or more common streams and the private stream based on parameters related to the at least common stream that corresponds to the common stream resource set to generate at least one demodulated common stream and demodulated private stream; and
decoding the private stream based at least on the demodulated private stream.

24-30. (canceled)
